(19) United States
(12) Patent Application Publication
(10) Pub. No.: US 2023/0336031 A1
(43) Pub. Date: Oct. 19, 2023

(54) WIRELESS CHARGING RACKS AND SYSTEMS

(71) Applicant: Cryoport, Inc., Brentwood, TN (US)

(72) Inventor: Eden Sanchez, Bellflower, CA (US)

(73) Assignee: Cryoport, Inc., Brentwood, TN (US)

(21) Appl. No.: 17/724,368

(22) Filed: Apr. 19, 2022

(51) Int. Cl. H02J 50/40; H02J 50/10; H02J 7/00

(52) U.S. Cl. CPC H02J 50/40; H02J 50/10; H02J 7/0013; H02J 7/0045; H02J 7/0047

(57) ABSTRACT

Wireless charging racks and systems for simultaneously charging a plurality of electronic devices are disclosed herein. A wireless charging rack may include one or more pillars. The one or more pillars may have a base to stand upright. The wireless charging rack may further include a plurality of shelves. Each of the plurality of shelves may be attachable to the one or more pillars, stackable on top of another, and distanced from another along the one or more pillars. The wireless charging rack may further include a plurality of wireless chargers. Each of the plurality of wireless chargers may be attachable to one of the plurality of shelves.

### BACKGROUND

### 1. Field

The various aspects and embodiments described herein relate to charging electronic devices, particularly wireless charging racks and systems for simultaneously charging multiple electronic devices.

### 2. Description of the Related Art

In industrial settings, a substantial number of electronic devices, especially portable devices such as smartphones, sensors, or data loggers, may be used in various applications, including measuring, detecting, tracking, recording, storing, and communicating data. For example, in the health, medical, pharmaceutical, and life science industries, data loggers are used to collect, store, and communicate data during storage and transportation of payload in a temperature-controlled environment to ensure payload quality. Generally, these portable devices are charged side by side or scattered in a charging environment, thereby taking up considerable space. Further, charging cords, power cords, extension cords, wireless charging stations and/or the like are used in great numbers to allow for simultaneous charging of a high number of devices. This may result in a disorganized charging setting. Even further, when portable devices with wireless charging capabilities are placed on a wireless charger, there is a risk that their inductive coils are misaligned or come out of alignment with the inductive coils of the wireless charging stations, thereby reducing charging speed and efficiency.

As such, there is a need for wireless charging racks and systems for simultaneously charging multiple electronic devices efficiently, effectively, and in a compact and organized fashion.

### SUMMARY

Wireless charging racks and systems for simultaneously charging multiple electronic devices are disclosed herein. The wireless charging racks and systems may charge the electronic devices via electromagnetic induction. A wireless charging rack may have multiple shelves that are stacked on top of another. Each shelf may have a wireless charger and be spaced from one another to place an electronic device over the wireless charger. The shelves may be supported by one or more pillars. The wireless charging rack may be secured on a cart along with other wireless charging racks to be stored and transported. The wireless chargers may be easily relocated and draw power from outlets disposed on the cart. Electronic devices that have completed charging may be removed from their shelves and stored in a storage container disposed on the cart.

In one aspect, the disclosure is embodied in a wireless charging rack. The wireless charging rack has one or more pillars. The one or more pillars have a base to stand upright. The wireless charging rack further has multiple shelves. Each shelf is attachable to the one or more pillars. Each shelf is also stackable on top of another and distanced from another along the one or more pillars.

These and other embodiments may optionally include one or more of the following features. A bottom shelf of the multiple shelves may be a base of the wireless charging rack and structurally support the one or more pillars. The one or more pillars or a barrier may prevent the multiple electronic devices placed on the multiple wireless chargers from falling off each of the multiple shelves in at least one direction. The multiple wireless chargers may be angled to align induction coils of the multiple electronic devices with induction coils of the multiple wireless chargers to charge the multiple electronic devices and for ease of electronic device installation. The one or more pillars may be a pair of proximal pillars being distanced apart by a first length and a pair of distal pillars being distanced apart by a second length. The first length may be greater than the second length. The pair of proximal pillars may be offset from the pair of distal pillars such that the distal pillars are within a boundary defined by parallel lines each passing through a center of a proximal pillar, the parallel lines being perpendicular to a line passing through the centers of the pair of proximal pillars. The multiple wireless chargers may each have an indicator that provides charging information to a user.

In another aspect, the disclosure is embodied in an inductive wireless charging system. The inductive wireless charging system has a base. The base has one or more openings. The inductive wireless charging system further has one or more pillars. The one or more pillars are insertable into the one or more openings. The inductive wireless charging system further has multiple shelves each attachable to the one or more pillars. Each of the multiple shelves are further stackable on top of another and distanced from another along the one or more pillars. The inductive wireless charging system further has multiple inductive wireless chargers each attachable to one of the multiple shelves and the base.

These and other embodiments may optionally include one or more of the following features. The one or more pillars or a barrier may prevent the multiple electronic devices placed on the multiple inductive wireless charges from falling off each of the multiple shelves and the base in at least one direction. The multiple inductive wireless chargers may be angled to align induction coils of the multiple electronic devices with induction coils of the multiple inductive wireless chargers to charge the multiple electronic devices. The one or more pillars may be a pair of proximal pillars being distanced apart by a first length and a pair of distal pillars being distanced apart by a second length. The first length may be greater than the second length. The pair of proximal pillars may be offset from the pair of distal pillars such that the distal pillars are within a boundary defined by parallel lines each passing through a center of a proximal pillar, the parallel lines being perpendicular to a line passing through the centers of the pair of proximal pillars.

The multiple inductive wireless chargers may each have an indicator that provides charging information to a user. A top surface of the base and top surfaces of the multiple shelves may be identical.

In yet another aspect, the disclosure is embodied in a wireless charging system. The wireless charging system includes one or more pillars. The one or more pillars have a base to stand upright. The wireless charging system further includes multiple shelves each attachable to the one or more pillars. Each of the multiple shelves are further stackable on top of another and distanced from another along the one or more pillars. The wireless charging system further includes multiple wireless chargers each attachable to one of the multiple shelves. The wireless charging system further includes a cart to store and transport the one or more pillars, the multiple shelves, and the multiple wireless chargers.

These and other embodiments may optionally include one or more of the following features. The wireless charging system may further include one or more electrical outlets attachable to the cart to supply power to the multiple wireless chargers. The wireless charging system may further include a container attachable to the cart to store one or more electronic devices of the multiple electronic devices that have completed charging.

A bottom shelf of the multiple shelves may be a base and structurally support the one or more pillars. The cart may include one or more shelves. The base may be removably attachable to the one or more shelves. The one or more pillars or a barrier may prevent the multiple electronic devices placed on the multiple wireless chargers from falling off each of the multiple shelves in at least one direction when the cart is stationary and being transported.

### BRIEF DESCRIPTION OF THE DRAWINGS

Other apparatus, methods, features, and advantages of the present disclosure will be apparent to one skilled in the art upon examination of the following figures and detailed description. Component parts shown in the drawings are not necessarily to scale and may be exaggerated to better illustrate the important features of the present disclosure.

FIG. 1 shows a front perspective view of a wireless charging rack according an aspect of the present disclosure;

FIG. 2 shows a rear perspective view of the wireless charging rack of FIG. 1 according to an aspect of the present disclosure;

FIG. 3 shows a side view of the wireless charging rack of FIG. 1 according to an aspect of the present disclosure;

FIG. 4 shows a top view of the wireless charging rack of FIG. 1 according to an aspect of the present disclosure;

FIG. 5 shows a front view of a wireless charging system according to an aspect of the present disclosure;

FIG. 6 shows a top view of the wireless charging system of FIG. 5 according to an aspect of the present disclosure;

FIG. 7 shows a side view of the wireless charging system of FIG. 5 according to an aspect of the present disclosure; and

FIG. 8 shows a magnified view of an attachment between a wireless charging rack and a cart according to an aspect of the present disclosure.

### DETAILED DESCRIPTION

Disclosed herein are wireless charging racks and systems for simultaneously charging multiple electronic devices. The wireless charging racks and systems may charge the electronic devices via electromagnetic induction where an induction coil of an electronic device is aligned with an induction coil of a wireless charger. The wireless charging racks may have a proximal side where an electronic device is placed on the rack from and a distal side opposing the proximal side and where the placed electronic device rests towards. A wireless charging rack may have multiple shelves that are stacked on top of another. The shelves may be supported by one or more pillars. Each shelf may have a wireless charger and be spaced from one another to place an electronic device over the wireless charger. The wireless chargers may be angled down from a proximal direction to a distal direction or, in other words, sloped between a high grade and a low grade where the proximal side is the high grade and the distal side is the low grade. The one or more pillars may be advantageously positioned to prevent an electronic device from falling off one of the shelves or sliding down along the distal direction and falling off of the shelves. The angle of the wireless chargers and the one or more pillars may advantageously align the induction coil of an electronic device with the induction coil of a wireless charger. A user may rest an electronic device against the one or more pillars or the barrier to ensure alignment. Alternatively, if an electronic device is initially placed such that there is misalignment resulting in no charging or interrupted charging, the angle of the wireless charger may eventually facilitate alignment by encouraging sliding down along the distal direction until stopped by the one or more pillars or the barrier. Each wireless charger may advantageously have an indicator that provides charging information (e.g., charging, not charging, charged) to the user.

A wireless charging system may further include a cart in addition to the wireless charging rack. The cart may store and transport multiple wireless charging racks. Each wireless charging rack may be secured onto a shelf of the cart to prevent or mitigate movement of electronic devices that are charging so that charging is not interrupted or stopped. The cart may advantageously include one or more electrical outlets for cable management and reducing cord lengths. The cart may include a container to store electronic devices that have completed charging.

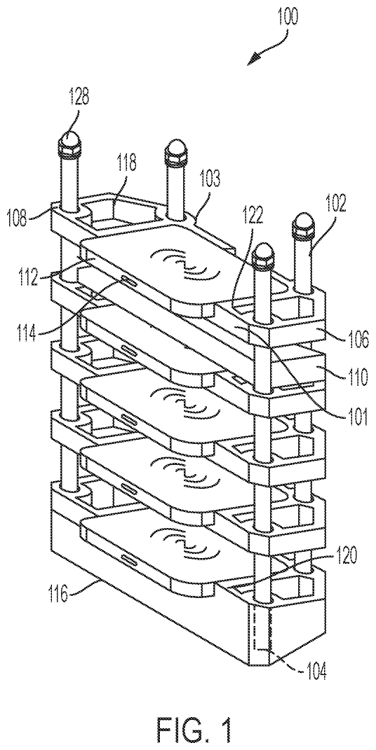

FIG. 1 shows a front perspective view of a wireless charging rack 100. A proximal side 101 of the rack 100 is in the front and a distal side 103 of the rack 100 is behind the rack 100. The rack 100 may have one or more pillars 102. In FIG. 1, four pillars are shown by example. A pillar 102 may have a base 104 to stand upright. The base 104 may be horizontally flat to support the pillar 102 on a horizontally flat surface. In other examples, the base 104 may be a connecting or fastening component to join with another component to support the base 104 (and thus the pillar 102) on a surface or on a cart. For example, the base 104 may include a male component, such as a threaded end or a sharp end, to mate with a female component to structurally support the pillar 102.

The rack 100 may further have a plurality of shelves 106. Five shelves 106 are shown by example in FIG. 1, but there may be more or less. Each shelf 106 may be attachable to the one or more pillars 102. The attachment may be facilitated by conventional fastening techniques such as mating, adhesives, screwing, threading along threads of a pillar 102, etc. In FIG. 1, each shelf 106 is shown as having a plurality of holes 108 that each receive a pillar 102. The holes 108 may be threaded or have a male or female component to mate with a corresponding female or male component located on the pillars 102. In another example, the shelves 106 may have cuffs that clip onto the pillars 102. In yet another example, the angle of each shelf 106 relative to each pillar 102 when placed over the pillars 102 may create friction that allows the shelf 106 to stay attached to the pillars 102 and in place until the angle is changed by force.

The shelves 106 may be stackable on top of another along the pillars 102. When stacked on top another, the shelves 106 may be parallel to each other. The shelves 106 may be distanced from another when stacked. The distance between each shelf 106 may be equal. The distance may allow for at least a portable electronic device 110 (e.g., smartphone, data logger, multimedia device, sensor, battery, etc.) to fit between two shelves 106. In some examples, the electronic device 110 may fit snugly between each shelf 106. In other examples, two shelves 106 may have adequate space between each other to allow for an adult hand or fingers to reach in and place or remove the electronic device 110 on a shelf 106.

The shelves 106 may be made of plastic, metal, wood, and/or the like. The shelves 106 may have gaps 118 and/or recesses to provide for a gripping location to hold, lift, and/or carry the rack 100 as well as conserve material. In some examples, the most bottom shelf 106 may form a base 116 of the rack 100. In such examples, the base 116 may have a horizontally flat surface that supports that the rest of the rack 100 on another horizontally flat surface. The base 104 of the pillars 102 may either contact the horizontally flat surface where the rack 100 is placed on or terminate within the base 116 of the rack 100 without being exposed to the horizontally flat surface. The base 116 may have a top surface 120 that is identical to top surfaces 122 of other shelves 106.

The pillars 102 may be made of plastic, metal, and/or wood. The pillars 102 may have an elongated or tubular shape. The pillars 102 may be cylindrical or a prism with two or more sides. The pillars 102 may have rounded top ends 128. The rounded top ends 128 may mitigate or prevent possibility of injury due to coming in contact with a sharp or pointed end. The round top ends 128 may be caps that are fitted over the pillars 102 or otherwise attachable. The round top ends 128 may have a feature that aids in keeping the round top end 128 static.

The rack 100 may further have a plurality of wireless chargers 112. Each wireless charger may or may not be attachable to a shelf 106. The attachment may be facilitated by conventional fastening techniques such as mating male and female components, adhesives, snap-fitting, bolting, material interference, and screwing. The wireless chargers 112 may use Qi, AirFuel, proprietary near-field magnetic coupling (NFMC), and/or similar wireless charging technologies. Each wireless charger 112 of the rack 100 may use the same wireless charging technology or vary in the wireless charging technology used.

Exterior of the wireless chargers 112 may be made of plastic, fabric, leather, or any other material that does not interfere with wireless power transfer. Each wireless charger 112 may have one or more induction coils that transfers power to one or more induction coils of the electronic device or devices 110. In some examples, multiple electronic devices 110 may be charged on the same wireless charger 112. For example, two electronic devices 110 may be placed crosswise in relation to a wireless charger 112 and charged simultaneously. Otherwise, a single electronic device 110 may be placed lengthwise in relation to a wireless charger 112 to be charged individually by that wireless charger 112. The wireless chargers 112 may be shaped and sized based on the shape and size of the electronic device 110 and/or the desired amount of electronic devices 110 to be charged simultaneously. Shelves 106 may have different shaped and sized wireless chargers 112. For example, the wireless chargers 112 may be rectangular, square, or circular. The wireless chargers 112 may fit within the shelves 106 or extend out of the shelves 106 as shown in FIG. 1. The wireless chargers 112 may or may not make contact with the electronic device 110 while charging or when charging is complete.

The wireless chargers 112 may have an indicator 114 that provides charging information to a user. The indicator 114 may inform a user that the electronic device 110 is charging, charged, or not charging. In some examples, the indicator 114 may inform a user of the same for multiple electronic devices 110. In some examples, there may be a plurality of indicators 114 each responsible for providing the charging status of a single electronic device 110. The indicator 114 may include a light and/or a display. For example, bulbs each having a different color may indicate each charging state with a unique color. In another example, an LED light may switch colors to indicate each charging state with a unique color. The indicator may be visual as shown in FIG. 1 or the indicator may be audible and/or haptic. In yet another example, the display may display an image, alphanumeric characters, and/or symbols to each charging state.

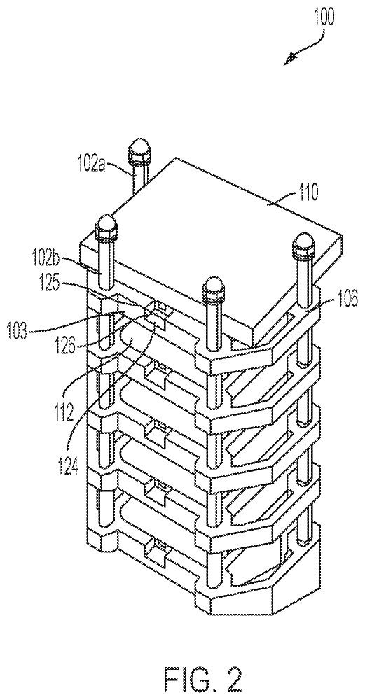

FIG. 2 shows a rear perspective view of the wireless charging rack 100. The one or more pillars 102 may be one or more proximal pillars 102a and one or more distal pillars 102b. In FIG. 2, two proximal pillars 102a and two distal pillars 102b are shown by example. The two distal pillars 102b may prevent the electronic device 110 from falling off the shelf 106. In some examples, a barrier or barriers separate from the distal pillars 102b may extend over a shelf 106 to prevent the electronic device 110 from falling off the shelf 106 instead of the distal pillars 102b.

The wireless chargers 112 and/or the shelves 106 may be angled at a predetermined angle to align induction coils of the electronic devices 110 with induction coils of the wireless chargers 112 and charge the electronic devices 110. In FIG. 2, both the wireless chargers 112 and the shelves 106 are angled and the angles are the same by example. In other examples, only the wireless chargers 112 may be angled while the shelves 106 are parallel to a resting surface or angled at a different angle. The angle may decline or create a downward slope towards the distal pillars 102b. The angle of the wireless chargers 112 along with the distal pillars 102b may ensure alignment of the induction coil of the electronic device 110 with the induction coil of the wireless charger 112. A user may rest the electronic device 110 against the distal pillars 102b as shown in FIG. 2 to ensure alignment between the induction coils. Alternatively, if the electronic device 110 is initially placed such that there is misalignment resulting in no charging or interrupted charging, the angle of the wireless charger 112 may eventually facilitate alignment between the induction coils. The angle may be between 5 degrees to 85 degrees. Preferably, the angle may be between 15 degrees to 60 degrees. Most preferably, the angle may be between and including 20 degrees and 45 degrees.

The shelves 106 may have a notch 124. The notch 124 may coincide with a power inlet 126 of a wireless charger 112. The notch 124 may provide a clear path for a power cord to be inserted into the power inlet 126 without structural interference. The notch 124 may be located on the distal side 103 of the rack 100. More specifically, the notch 124 may interrupt an upper face 125 of a shelf 106 on the distal side 103. The interruption may occur at the middle of the distal side 103.

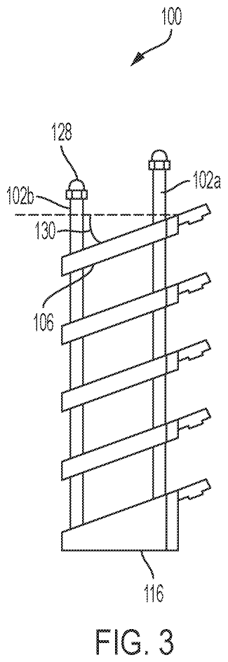

FIG. 3 shows a side view of the wireless charging rack 100. The shelves 106 may be parallel to each other by example. The angle 130 may be about 20 degrees also by example. In some examples, the pillars 102 may each have the same length. In other examples, either the proximal pillars 102a or the distal pillars 102b may have a greater length than the other. For instance, if the top ends 128 are to be leveled and the proximal pillars 102a have a higher inception point, meaning the proximal pillars 102a are grounded at a higher point within the base 116, than the distal pillars 102b, the proximal pillars 102a may be made shorter than the distal pillars 102b.

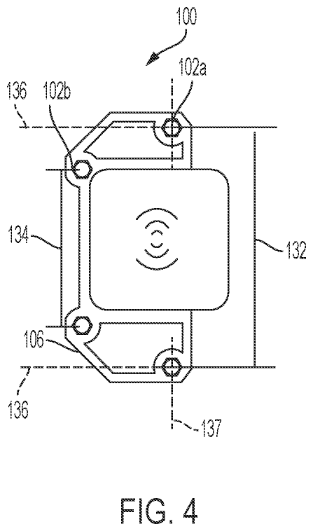

FIG. 4 shows a top view of the wireless charging rack 100. The proximal pillars 102a may be distanced apart by a first length 132. The distal pillars 102b may be distanced apart by a second length 134. The first length 132 may be greater than the second length 134. The proximal pillars 102a may be offset from the distal pillars 102b such that the distal pillars 102b are within a boundary 136 shown by dashed lines in FIG. 4. The boundary 136 may be defined by the proximal pillars 102a. The lines of the boundary 136 may be parallel to each other pass through a center of each proximal pillar 102a and perpendicular to dashed line 137 passing through the centers of both proximal pillars 102a. Due to the difference in lengths and positioning, an electronic device 110 (see FIG. 2) may have a clear path to go through between the proximal pillars 102a and then get blocked by the distal pillars 102b to prevent the electronic device 110 from sliding or falling off the shelf 106. The pillars 102a may or may not position the center of mass of the electronic device 110 before, at, or after the dashed line 137.

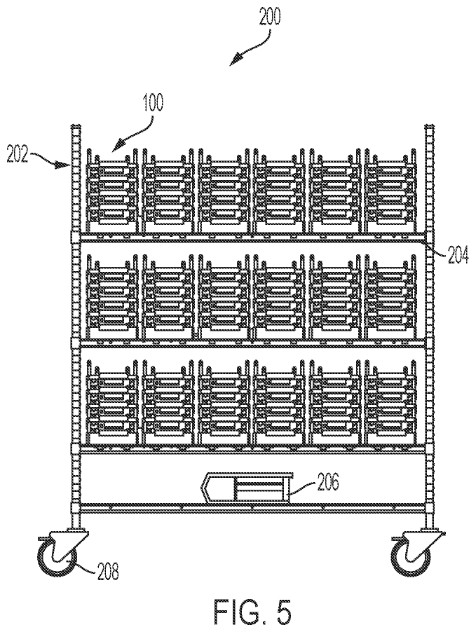

FIG. 5 shows a front view of a wireless charging system 200. The system 200 may include the rack 100 and a cart 202. The cart 202 may store and transport one or more racks 100. The cart 202 may be made of metal, plastic, and/or wood by example. The cart 202 may have one or more shelves 204. Four shelves 204 are shown in FIG. 5 by example. Racks 100 may be disposed or attached side-by-side along one, some, or all of the shelves 204. One or more shelves 204 may have a container or containers 206 disposed or attached on top. The shelf 204 supporting the container 206 may have less vertical room than the shelf or shelves 204 supporting racks 100 to save space. The container 206 may store one or more electronic devices 110 (see FIG. 2) that have completed charging. Hence, charging space may be opened up for other electronic devices 110 that need charging. Further, the container 206 may contain power cords, extension cords, and/or the like for general storage and extra supply. The cart 202 may be shaped and sized based on a desired capacity for racks 100 and containers 206. In FIG. 5, the cart 202 may have capacity for 18 racks 100. The cart 202 may have one or more wheels 208. In some examples, the cart 202 may have four wheels 208 to balance the cart 202 and prevent or mitigate contents of the cart 202 from falling off. In some examples, any or all of the four wheels 208 may have a locking feature that keep the cart static when the locking feature is activated. In other examples, the cart 202 may have a handlebar to push and pull the cart 202.

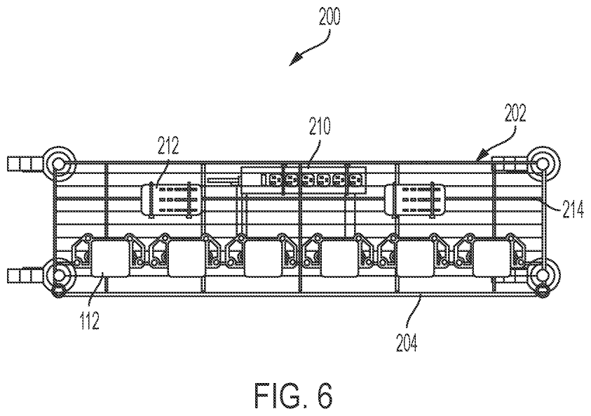

FIG. 6 shows a top view of the wireless charging system 200. The cart 202 may include one or more electrical outlets 210. The electrical outlets 210 may be disposed on or attached to one or more shelves 204. The electrical outlets 210 may or may not have internal electrical protection. The shelves 204 may be formed of a plurality of bars 214. The electrical outlets 210 may be in the form of a power strip as shown in FIG. 6. The electrical outlets 210 may supply power to the wireless chargers 112. The electrical outlets 210 may be plugged in to a wall outlet or draw power from a power source on the cart 202. The electrical outlets may be 3-pronged or any other conventional outlet. Power may be supplied directly or indirectly. In some examples, outlet multipliers 212 electrically connected to the electrical outlets 210 may serve as an intermediary in the power transfer. The number of outlet multipliers 210 may vary. The outlet multipliers 212 may have two or more outlets in the form of 3-pronged, USB-A, USB-C, and/or the like. The outlet multipliers 212 may allow for more wireless chargers 112 to have power supply and help with cable management. The electrical outlets 210 and the outlet multipliers 212 may be fastened to the cart 202 via conventional fasteners, such as screws, hooks, clips, adhesives, Velcro, zip ties, and/or the like. Gaps between the bars 214 may be utilized for a variety of these fasteners.

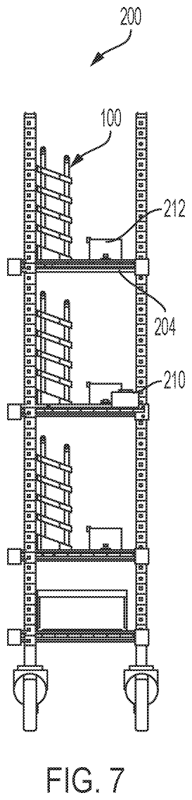

FIG. 7 shows a side view of the wireless charging system 200. There may be one row of racks 100 on each shelf 204 by example. In other examples, there may be more rows of racks 100. Next to each row of racks 100 on each shelf 204 may be the electrical outlets 210 and the outlet multipliers 212. In some examples, there may be one central electrical outlet 210 where all the outlet multipliers 212 are plugged into as shown in FIG. 7.

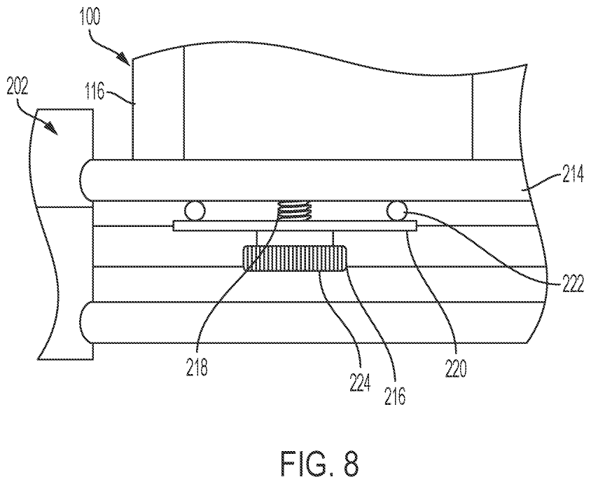

FIG. 8 shows a magnified view of an attachment between a wireless charging rack 100 and the cart 202. The attachment may be facilitated by a fastening hardware 216. The hardware 216 may be coupled to a base 116 of the rack 100 from under the shelf 204 and between two bars 214 of the shelf 204. The hardware 216 may have a threaded screw portion 218. The screw portion 218 may be screwed inside a threaded screw hole defined by the base 116 by twisting a knob 224. The screw portion 218 may be tightened by an Allen wrench by example. The hardware 216 may have a plate 220 that is wide enough to apply force against the two bars 214 to fix the rack 100 to the cart 202. One or more spacers 222 may be disposed in between the plate 220 and the bars 214. FIG. 8 may or may not employ features that will maintain the threaded screw portion 218, the plate 220, the hardware 216, and the knob 224 centered between the spacers 222.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A wireless charging rack for simultaneously charging a plurality of electronic devices comprising:
one or more pillars having a base to stand upright;
a plurality of shelves each attachable to the one or more pillars, stackable on top of another and distanced from another along the one or more pillars; and
a plurality of wireless chargers each attachable to one of the plurality of shelves.

2. The wireless charging rack of claim 1, wherein a bottom shelf of the plurality of shelves is a base of the wireless charging rack and structurally supports the one or more pillars.

3. The wireless charging rack of claim 1, wherein the one or more pillars or a barrier prevents the plurality of electronic devices placed on the plurality of wireless chargers from falling off each of the plurality of shelves in at least one direction.

4. The wireless charging rack of claim 3, wherein the plurality of wireless chargers are angled at an angle to align induction coils of the plurality of electronic devices with induction coils of the plurality of wireless chargers to charge the plurality of the electronic devices.

5. The wireless charging rack of claim 3, wherein the one or more pillars are a pair of proximal pillars being distanced apart by a first length and a pair of distal pillars being distanced apart by a second length, the first length being greater than the second length.

6. The wireless charging rack of claim 5, wherein the pair of proximal pillars are offset from the pair of distal pillars such that the distal pillars are within a boundary defined by parallel lines each passing through a center of a proximal pillar, the parallel lines being perpendicular to a line passing through the centers of the pair of proximal pillars.

7. The wireless charging rack of claim 1, wherein the plurality of wireless chargers each have an indicator that provides charging information to a user.

8. An inductive wireless charging system for simultaneously charging a plurality of electronic devices comprising:
a base having one or more openings;
one or more pillars insertable into the one or more openings;
a plurality of shelves each attachable to the one or more pillars, stackable on top of another, and distanced from another along the one or more pillars; and
a plurality of inductive wireless chargers each attachable to one of the plurality of shelves and the base.

9. The inductive wireless charging system of claim 8, wherein the one or more pillars or a barrier prevents the plurality of electronic devices placed on the plurality of inductive wireless chargers from falling off each of the plurality of shelves and the base in at least one direction.

10. The inductive wireless charging system of claim 9, wherein the plurality of inductive wireless chargers are angled to align induction coils of the plurality of electronic devices with induction coils of the plurality of inductive wireless chargers to charge the plurality of the electronic devices.

11. The inductive wireless charging system of claim 9, wherein the one or more pillars are a pair of proximal pillars being distanced apart by a first length and a pair of distal pillars being distanced apart by a second length, the first length being greater than the second length.

12. The inductive wireless charging system of claim 11, wherein the pair of proximal pillars are offset from the pair of distal pillars such that the distal pillars are within a boundary defined by parallel lines each passing through a center of a proximal pillar, the parallel lines being perpendicular to a line passing through the centers of the pair of proximal pillars.

13. The inductive wireless charging system of claim 8, wherein the plurality of inductive wireless chargers each have an indicator that provides charging information to a user.

14. The inductive wireless charging system of claim 8, wherein a top surface of the base and top surfaces of the plurality of shelves are identical.

15. A wireless charging system for simultaneously charging a plurality of electronic devices comprising:
one or more pillars having a base to stand upright;
a plurality of shelves each attachable to the one or more pillars, stackable on top of another, and distanced from another along the one or more pillars;
a plurality of wireless chargers each attachable to one of the plurality of shelves; and
a cart to store and transport the one or more pillars, the plurality of shelves, and the plurality of wireless chargers.

16. The wireless charging system of claim 15, further comprising one or more electrical outlets attachable to the cart to supply power to the plurality of wireless chargers.

17. The wireless charging system of claim 15, further comprising a container attachable to the cart to store one or more electronic devices of the plurality of electronic devices that have completed charging.

18. The wireless charging system of claim 15, wherein a bottom shelf of the plurality of shelves is a base and structurally supports the one or more pillars.

19. The wireless charging system of claim 18, wherein the cart includes one or more shelves, the base being removably attachable to the one or more shelves.

20. The wireless charging system of claim 15, wherein the one or more pillars or a barrier prevents the plurality of electronic devices placed on the plurality of wireless chargers from falling off each of the plurality of shelves in at least one direction when the cart is stationary and being transported.
